(19) United States
(12) Patent Application Publication
(10) Pub. No.: US 2023/0344088 A1
(43) Pub. Date: Oct. 26, 2023

(54) ENERGY STORAGE MODULE FOR STORING ELECTRIC ENERGY

(71) Applicant: SCIO TECHNOLOGY GMBH, Aschaffenburg (DE)

(72) Inventors: Alexander WEIS, Hösbach (DE); Michael NOLL, Sulzbach (DE); Alexander SEGER, Maintal (DE)

(21) Appl. No.: 18/015,850

(22) PCT Filed: Jul. 15, 2020
(86) PCT No.: PCT/DE2020/100617

§ 371 Date: Jan. 12, 2023

(51) Int. Cl. H01M 50/507; H01M 50/262; H01M 50/271; H01M 50/517

(52) U.S. Cl. CPC H01M 50/507; H01M 50/262; H01M 50/271; H01M 50/517

(57) ABSTRACT

An energy storage module for storing electric energy, comprising an energy storage device having a top surface, a bottom surface, and a substantially rectangular outer periphery.

### CROSS-REFERENCE TO RELATED APPLICATIONS

This application is a U.S. National Phase application under 35 U.S.C. 371 of International Application No. PCT/DE2020/100617, filed on Jul. 15, 2020. The entire disclosure of the above application is incorporated herein by reference.

### BACKGROUND

This section provides background information related to the present disclosure which is not necessarily prior art.

### TECHNICAL FIELD

The invention relates to an energy storage module for storing electric energy, comprising an energy storage device having a top surface, a bottom surface, and a substantially rectangular outer periphery, the energy storage device comprising a plurality of energy storage units, each of the energy storage units having at least two adjacent energy storage cells with poles aligned with the top surface and the bottom surface of the energy storage device, the positive poles of each of the energy storage units being interconnected via a first electrically conductive cell connector and the negative poles being interconnected via a second electrically conductive cell connector, and the first cell connector is electrically connected to a first connecting lug and the second cell connector is electrically connected to a second connecting lug, the connecting lugs being arranged on an outer side of the energy storage unit facing a first side surface of the rectangular outer periphery of the energy storage unit, the first connecting lug of each of the energy storage units being connected to the second connecting lug of the respective energy storage unit adjacent in a longitudinal direction of the first side surface via an electrically conductive connecting element. An energy storage module of this type is known, for example, from JP 2016-91959 A. Further energy storage modules are also known from WO 2020/071642, FR 3 077 431 and US 2015/0 180 093 A1.

### DISCUSSION

One problem of energy storage modules is that the modules heat up strongly during operation, especially under high load, and expand as a result. These temperature-dependent changes in volume, especially in relation to the outer circumference of the energy storage cells, mean that the energy storage cells cannot be arranged directly next to one another, as the resulting pressure poses the risk of destroying the energy storage cells and the infrastructure surrounding them, or the entire energy storage module. It is therefore necessary to maintain a predetermined distance between the energy storage cells during the production of energy storage modules, which is based on the expected thermal expansion of the energy storage cells. At the same time, due to performance requirements or a steadily increasing demand for energy storage capacity on the one hand and limited available space on the other, for example in electrically powered vehicles, it is necessary to accommodate as many cells as possible in a small space in order to achieve a high power density. Furthermore, a constant goal of further developments in the field of energy storage modules is to reduce material requirements and weight in order to achieve greater cost savings in terms of energy efficiency.

The disadvantage here is that additional elements are required to separate the energy storage cells from each other both for manufacturing the energy storage modules, in particular for positioning the energy storage cells, and for spatially separating the cells from each other, which make the modules unnecessarily complex and lead to increased manufacturing costs and at the same time have a negative effect on the possible packing density of the energy storage cells.

### SUMMARY

This section provides a general summary of the disclosure, and is not a comprehensive disclosure of its full scope or all of its features.

The present invention is therefore based on overcoming the disadvantages of the prior art, and in particular of improving an energy storage module in such a way that it can be manufactured particularly easily with a particularly compact and material-saving design and has a high degree of stability.

Accordingly, it is provided that the energy storage module further comprises a housing with a side wall associated with the first side surface, to which the connecting elements are fastened in such a way that they can be fastened to the connection lugs associated with them.

Due to its rectangular outer circumference, the energy storage unit can extend in a longitudinal dimension along the side surfaces and in a transverse dimension along the end surfaces. In particular, the width of an energy storage unit can correspond to twice the diameter of an energy storage cell plus the provided expansion gap. The longitudinal dimension may therefore correspond in particular to the width of an energy storage unit multiplied by the number of energy storage units plus the number of expansion gaps provided between the energy storage units. The provided expansion gaps may thereby correspond to the maximum expected radial expansion of two adjacent cells, where the expected radial expansion may depend on the maximum expected operating temperature. The maximum expected operating temperature may depend on the type of use or even the location of use. The axes of adjacent energy storage cells may be arranged so that an equilateral triangle is formed between each of them. This arrangement allows the lowest possible energy storage cell density to be achieved. The energy storage unit may have a plurality of pairs of energy storage cells offset from each other in a zigzag manner in its transverse dimension due to, among other things, the arrangement in equilateral triangles. As a result, the spacing between two pairs of energy storage cells may be the sum of the energy storage cell diameter plus the provided elongation spacing multiplied by a factor of √3/2. Accordingly, the transverse dimension of the energy storage unit may be the number of energy storage cell pairs arranged side by side in the transverse direction subtracted by the value 1 multiplied by the above-mentioned spacing of two energy storage cell pairs. The energy storage cells can be cylindrical, and have a non-conductive cylindrical shell. In particular, the axes of the cylindrical cells can be aligned parallel to each other. The energy storage cells can be battery cells or capacitor cells, for example. Spacing of the cells of an energy storage unit relative to one another to the intended expansion gap can be effected in particular by the cell connectors connecting the positive poles on the one hand and the negative poles on the other hand. The cell connectors thus connect the cells of an energy storage unit in a parallel circuit. The cell connectors can be welded onto the cells, for example. Additional spacers between the cells can thus be dispensed with. The connecting elements serve the purpose of contacting the energy storage units with each other on the one hand, and on the other hand of keeping directly adjacent cells of adjacent energy storage units at the intended expansion gap. By arranging the connecting elements on the side surfaces of the energy storage unit or on the non-conductive surfaces of the energy storage cells, the connection of the energy storage units to one another is simplified on the one hand and the torsional stiffness of the energy storage unit is increased on the other. Compared with the method of connecting energy storage units, in which the connecting elements are provided alternately on the top and bottom sides between the energy storage units, so that the necessary complaint cannot be reliably ensured on the top or bottom sides that are not connected in each case, the method of connection according to the invention has the advantage that the lateral connection achieves increased stability of the energy storage unit. The connecting elements connect the energy storage units to each other in series. It may be provided that the connection lugs are integrally connected to the cell connectors and are bent over onto the outer surfaces of the energy storage cells at the sides of the energy storage units, respectively. The connecting lugs can optionally be bent centrally between the two energy storage cells of the energy storage unit or only onto one of the energy storage cells. As a result, the connecting lugs can face each other on the top and bottom sides of the side surface of the energy storage unit and, in particular, be spaced apart from each other. The connecting lugs can in particular be sheet metal sections and have a rectangular or semicircular shape. The connecting element may be, for example, a connecting sheet or a wire. The connecting sheet can, for example, be fastened in each case with its end sections to the associated connection lugs.

Since the energy storage module has a housing with a side wall associated with the first side face, to which the connecting elements are fastened in such a way that they can be fastened to the terminal lugs associated with them, the alignment of the connecting elements with the associated connection lugs can thus be predetermined by the side wall geometry. It may be envisaged that contacting of the connecting lugs with the connecting elements is achieved by fastening the side wall to the energy storage module. For this purpose, the connecting elements can be pretensioned relative to the side panel, for example via pretensioning elements.

Furthermore, the side panel can have fixing windows associated with the connection lugs and aligned with them, via which the connecting elements can be fixed to the connection lugs from the outside of the housing. The fixing windows can be openings made in the side wall. The fixing windows can correspond to the geometry of the connection lugs. By means of the fixing windows, the connecting elements can be welded to the connecting lugs after the side panel has been assembled. The pre-aligned connecting elements thus eliminate the need for separate adjustment of the connecting elements on the connection lugs, so that the energy storage module can be manufactured quickly and cost-effectively.

In addition, the side wall can have at least one, in particular two, latching element per fixing window adjacent to the fixing window for fixing the connecting element assigned to the fixing window. The latching elements can be provided in particular on the side of the side wall facing the energy store. The latching elements can in particular have a contact surface and a latching projection. For each contact surface, provision can be made for limiting a degree of freedom of the connecting element. For example, the connecting element can have a rectangular shape and a latching element with a contact surface associated with the respective outer side can be provided on each of the outer sides of the connecting element. This allows the connecting element to be anchored to the side wall. In particular, two latching elements with contact surfaces aligned perpendicularly to one another and facing one another can be provided for each fixing window. The adjacent fixing window to which the other end of the connecting element is to be fixed likewise has two latching elements with contact surfaces aligned perpendicularly to one another and facing one another or to the contact surfaces of the associated adjacent fixing window. The latching projections adjoin the contact surfaces so that the contact surfaces lie behind the latching projections in an undercut manner. In this way, the fasteners can be aligned to the assigned position for assembly and clicked into the latching projections. The side panel together with the assembled connecting elements can then be fixed to the energy storage module and the connecting elements welded to the associated connection lugs. The contact surfaces can have a width that allows fasteners with a thickness of 0.8 mm, for example, to be accommodated.

In addition, the side panel can also have a plurality of spring elements, in particular a number corresponding to the number of energy storage cells, for generating a preload between the side panel and the energy storage device when the side panel is mounted. For this purpose, clamping webs can be formed on the side wall, for example, which extend away from the side wall at an angle with their opposite end. The clamping webs can have a spring travel of 2 mm, for example. The spring elements can be arranged both near the top edge and near the bottom edge of the side wall. The clamping webs at the upper edge can extend in the direction of the upper edge and the clamping webs at the lower edge can extend in the direction of the lower edge.

Furthermore, the housing may comprise a bottom and/or a lid, wherein the side wall may have a longitudinally extending corner recess at its upper and/or lower edge for vertically supporting and laterally fixing the bottom and/or the lid. The lid and the bottom may be dimensioned to have at least the longitudinal dimension and the transverse dimension of the energy storage device and, moreover, to rest on the corner recess of the side wall.

In addition, the side panel can also have a plurality of fastener receptacles facing the upper and/or lower edge, via which the bottom and/or the lid can be fixed to the associated corner recesses. The fastening element receptacles can each have support surfaces which lie on the plane of the corner recesses. The fastener receptacles can be integrally formed on the side wall. The fastener receptacles can be screw connection points having holes. The screw connection points can have countersunk holes. A free space extending in the longitudinal direction may be provided between the fastener receptacles at the upper edge and the fastener receptacles at the lower edge and between the upper and lower fixing windows. In the area of the free space, a groove running in the longitudinal direction can be provided in the side panel. The groove can be a cable duct, for example. In the region of the groove, the side wall can have at least one aperture for the passage of cables. For example, an opening can be provided between the upper and lower screw connection points.

Furthermore, the side wall may have a stiffening part extending substantially in the longitudinal direction of the side wall on its side facing away from the energy storage device, the stiffening part having a plurality of apertures aligned with the fixing windows. The stiffening part may be made of metal. The side wall may have a longitudinal groove on its outer surface in which the stiffening part is received. The stiffening part may further include a plurality of apertures aligned with the cable passage apertures. The stiffening part may further have fastening tabs projecting longitudinally laterally beyond the side wall for connecting the side wall to the adjacent housing walls.

Furthermore, on at least one of the end faces of the rectangular outer circumference of the energy storage unit, the housing can comprise a head part covering the adjacent energy storage unit, which head part has a plurality of fastening element receptacles pointing towards the upper and/or lower edge of the head part, via which the bottom and/or the lid can be fixed to the head part bar. The fastener receptacles may correspond to the fastener receptacles of the side panel. The head part can further have a plurality of spring elements for generating a pretension between the head part and the energy storage device in the assembled state of the head part. The spring elements can be designed to correspond to the side wall.

Further, the head part may be connected to the free connecting lug of the adjacent energy storage unit via at least one electrically conductive terminal element. The electrically conductive terminal element may have a first portion extending substantially perpendicularly away from the head part. The connecting element may further include a second portion that is disposed parallel to the head part and by which the connecting element is attached to the head part. The connecting element may be, for example, an electrically conductive sheet. The second section may be bent over from the first section, in particular at right angles.

In addition, the first cell connector can be electrically connected to a third connecting lug and the second cell connector can be electrically connected to a fourth connecting lug, which are arranged on a second side surface of the rectangular outer circumference of the energy storage unit, which side surface is opposite the first side surface, with the third connecting lug of the energy storage units being connected in each case via an electrically conductive connecting element to the fourth connecting lug of the energy storage unit which is adjacent in each case in a longitudinal direction of the first side surface. Connecting elements on both sides of the energy storage unit increases the stability of the energy storage unit and, in particular, ensures reliable spacing of the energy storage cells from one another.

In particular, the housing may further comprise a side wall associated with the second side surface, which may have the same features as the opposite first side wall. In particular, the side walls may be identical parts.

The energy storage module can comprise, for example, seven, ten or thirteen energy storage units, or possibly even more, which are arranged next to each other in the longitudinal direction of the side wall. In addition, the energy storage module can be expanded to any desired current strength by varying the energy storage cells per energy storage unit, as well as to any voltage by varying the number of energy storage units.

It may be provided that the at least two energy storage cells of the energy storage units are adjacent in the longitudinal direction of the side wall, the energy storage unit further comprising a plurality of further pairs of energy storage cells each adjacent in the longitudinal direction of the side wall, the plurality of energy storage cell pairs extending in a direction transverse to the side wall.

In addition, it can be provided that all positive and all negative poles of the energy storage cells are aligned to the upper side or to the lower side of the energy storage unit, so that the connecting elements connect adjacent energy storage units diagonally. Diagonal connection can achieve particularly high stability of the module, as this is the most effective way of preventing the energy storage units from tilting relative to one another.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Exemplary embodiments of the invention are explained with reference to the following figures. Thereby shows:

FIG. 1 an exploded view of an embodiment of the energy storage module;

FIG. 2 a perspective view of an embodiment of the energy storage module in the assembled state;

FIG. 3 a top view of an embodiment of the energy storage module in the assembled state;

FIG. 4 a perspective view of an embodiment of the side wall of the energy storage module;

FIG. 5a/b two perspective views of an embodiment of the front head section in front and rear view;

FIG. 6a/b two perspective views of an embodiment of the rear head section in front and rear view.

### DETAILED DESCRIPTION

Example embodiments will now be described more fully with reference to the accompanying drawings.

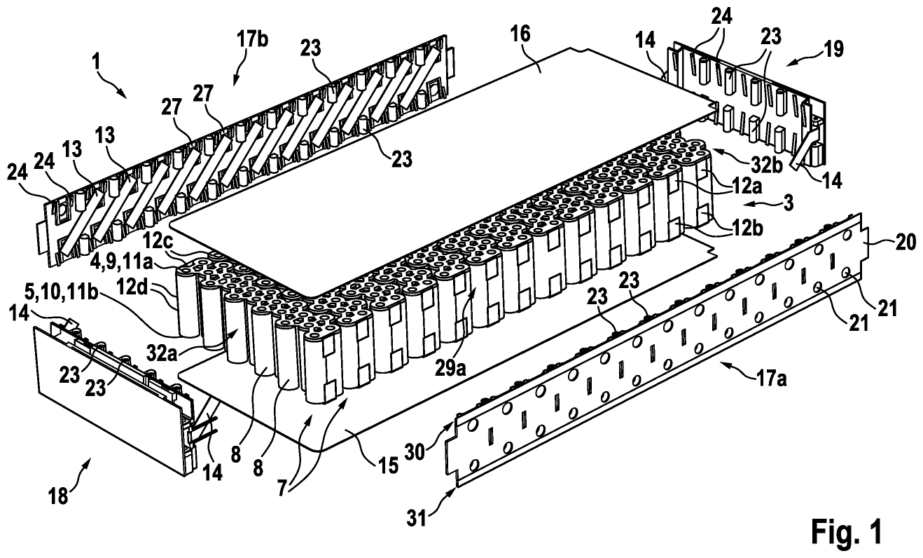

The energy storage module 1 shown in FIG. 1 has an energy storage device 3 consisting of thirteen energy storage units 7 arranged next to each other in the longitudinal direction, each of which has eleven pairs of energy storage cells arranged next to each other in the transverse direction, i.e. twenty-two energy storage cells 8 each. The energy storage cells 8 are each cylindrical and aligned with their axes parallel to each other. The energy storage cell pairs are arranged next to each other in a zigzag shape, so that the distances between all energy storage cells 8 are such that their axes form equilateral triangles to each other. Thereby, a predetermined expansion distance is provided between all energy storage cells 8, which compensates for expansion of the energy storage cells 8 during operation of the energy storage module 1.

On the upper side 4 of the energy storage device 3, a first cell connector 11a is arranged on each energy storage unit 7 in each case, which electrically connects the upwardly pointing positive poles 9 of the energy storage cells 8 to one another and at the same time keeps the energy storage cells 8 at their predetermined distance from one another. Similarly, a second cell connector 11b is arranged on the lower side 5 of the energy storage device 3 on each energy storage unit 7, which connects the negative poles of all energy storage cells 8 of the respective energy storage units 7 to one another and also keeps the energy storage cells 8 at their predetermined distance from one another on the underside.

The energy storage units 7 are arranged relative to each other such that the energy storage device 3 has side surfaces 29a, 29b extending in the longitudinal direction of the energy storage module 1. The cell connectors 11a and 11b each have connecting lugs 12a, 12b, 12c, 12d which are respectively bent over onto the side surface 29a and side surface 29b so that the connecting lugs 12a and 12b of each energy storage unit 7 respectively face each other on the side surface 29a and the connecting lugs 12c and 12d of each energy storage unit 7 respectively face each other on the opposite side surface 29b.

The energy storage module 1 further comprises a housing 2 having side walls 17a and 17b, a front side head part 18, a rear side head part 19, and a bottom 15 and a lid 16. While the lid 16 covers the upper side 4 of the energy storage module 1 and the bottom 15 covers the lower side 5 of the energy storage module 1, the side walls 17a and 17b are arranged along the side surfaces 29a, 29b of the energy storage module 3, and the head parts 18 and 19 are arranged on the front sides of the end faces 32a, 32b of the energy storage module 1, respectively. The side walls 17a and 17b each have latching elements 25, via which electrical connecting elements 13 are each fastened diagonally and facing the energy storage module 3 to the side walls 17a, 17b. As a result, the connecting elements 13 are already aligned by placing the side walls on the side surfaces in such a way that they are connected or can be connected to the corresponding connection lugs twelve A to twelve the. It can be seen that one two latching elements 25 are provided for each connecting tab 12a-12d, in each of which an end section of a connecting element 13 is held. It can be seen that from left to right of the energy storage module 1, the connecting elements 13 each connect a lower connecting lug 12b or 12d of a first energy storage unit 7 to an upper connecting lug 12a or 12c of a second energy storage unit 7 arranged to the right of the first energy storage unit 7. The connection lugs that remain free are each connected via terminal elements 14 attached to the head parts. In FIG. 1, this relates to the connection lugs 12a and 12c of the energy storage unit 7 adjacent to the front head part 18 and the connection lugs 12b and 12d of the energy storage unit 7 adjacent to the rear head part 19. The connection elements 13 can, for example, be pretensioned via spring elements so that an electrical connection is already established between the connection lugs 12a-12d and the respective connection elements 13 when the side panels are placed on the energy storage module 1. The side panels 17a and 17b further comprise stiffening parts 20, each of which is received in a recess 26 extending in the longitudinal direction of the side panels 17a, 17b and increases the flexural rigidity of the side panels 17a, 17b. The side walls 17a and 17b further have fixing windows 27, which are respectively aligned with the connecting tabs 12a to 12d and the end portions of the connecting elements 13 attached to the side walls. The stiffening parts 20 mounted on the side walls 17a, 17b have corresponding apertures 21 which are also aligned with the fixing windows 27, so that a connection of the connecting elements 13 with the respective connecting lugs 12a-12d can be made from the outside of the housing in the assembled state of the side walls 17a, 17b, for example by welding.

The bottom 15 and the lid 16 are connected to the outer housing elements. For this purpose, the side walls 17a, 17b and the head parts 18, 19 each have a plurality of regularly spaced fastening element receptacles 23, which are arranged along the upper edge 30 and the lower edge 31 of the outer housing elements, respectively, and point in the direction of lid 16 or bottom 15. As shown in FIG. 1, the fastening element receptacles 23 are designed as screw connection points for countersunk screws, so that lid 16 and bottom 15 can be screwed to the outer housing elements. Furthermore, a plurality of spring elements 24 are arranged on the outer housing elements, which can be designed as clamping webs as shown. These are formed at regular intervals in two rows on the housing elements and extend at an acute angle from the housing elements in the direction of the energy store 3. The clamping webs can have a spring travel of 2 mm, for example. The spring elements 24 serve the purpose of creating a preload between the respective housing wall and the energy store in order to achieve a central positioning of the energy store 3 in the housing 2 and to protect the energy store 3 against impacts.

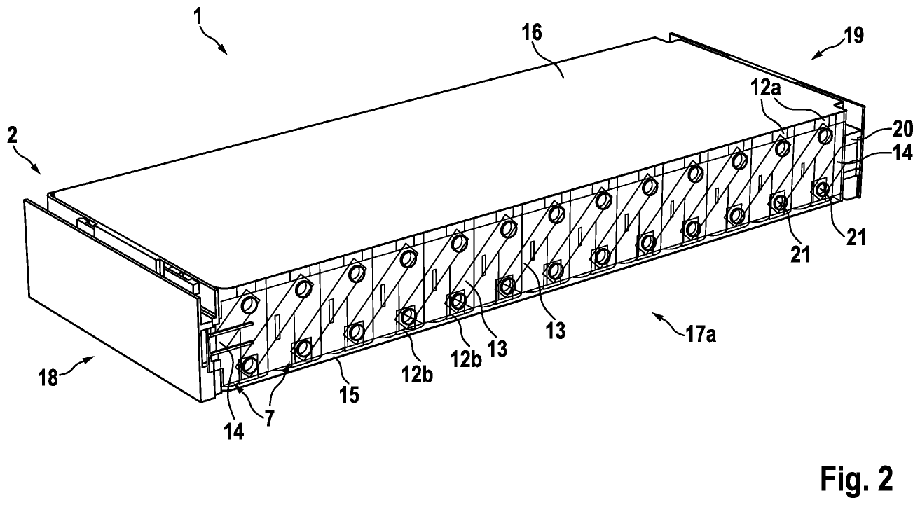

FIG. 2 shows the energy storage module 1 in the assembled state, i.e. the energy storage device 3, which is accommodated in the housing 2, wherein the side walls 17a and 17b are respectively connected to the front-side head part 18 and the rear-side head part 19, and the lid 16 and the bottom 15 are respectively screwed to the housing outer shell. In particular, it is shown how the connecting tabs 12a-12d are connected to the connecting elements 13. In this regard, the connecting lug 12a of the energy storage unit 7 adjacent to the front-side head part 18 is electrically connected to the terminal element 14 attached to the front-side head part 18. The connecting lug 12b of the energy storage unit 7 adjacent to the rear-side head part 19 is electrically connected to the terminal element 14 attached to the rear-side head part 19. In this case, the terminal elements 14 are each connected centrally to the head elements 18, 19 and are each angled parallel to the further connection elements 13. The connecting elements 13 each connect adjacent energy storage units 7 to one another in such a way that the connecting element 13 runs from the lower connecting lug 12b of a left-hand energy storage unit 7 to the upper connecting lug 12a of a right-hand energy storage unit 7 arranged next to it on the right. It can be seen that the connection points between the connecting elements 13 and the respective connecting lugs 12a-12d can each be accessed from the outside of the housing through the apertures 21 in the stiffening part 20 and the fixing windows 27 in the side walls 17A, 17b. This allows the connecting lugs to be welded to the respective ends of the connecting elements 13 after the side walls have been fitted. The opposite side of the energy storage module 1, which is not shown, is formed symmetrically with respect to the side shown, so that the connecting elements 13 there connect adjacent energy storage units 7 to one another in such a way that the connecting element 13 runs from the lower connecting tab 12d of a left-hand energy storage unit 7 to the upper connecting tab 12c of a right-hand energy storage unit 7 arranged next to it on the right.

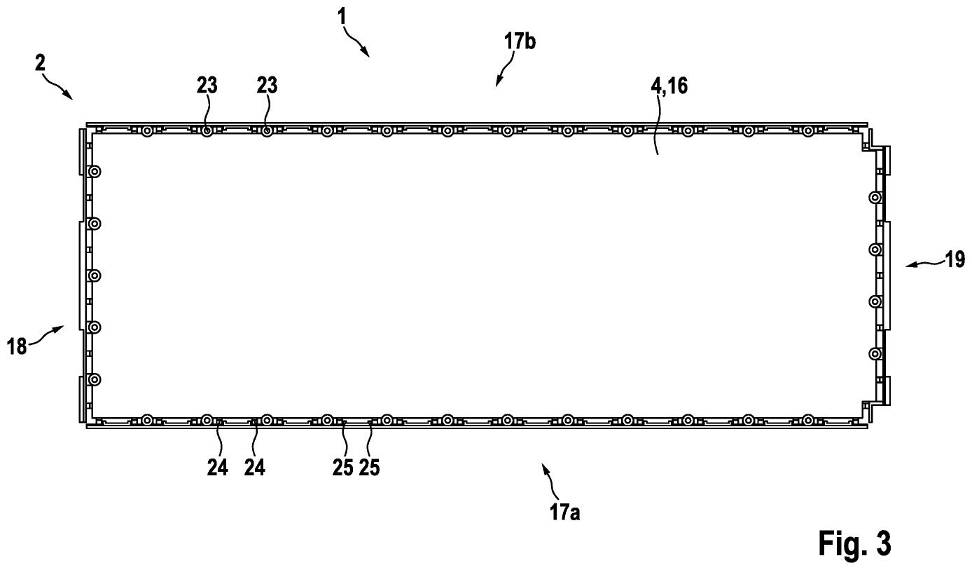

The top view of an energy storage module 1 shown in FIG. 3 shows in particular the connection of the side elements 17a, 17b to the lid 16 on the upper side 4 of the energy storage module 3. The connection of the outer housing elements to the bottom 15 is made in the same way. For this purpose, the side walls 17A and 17B and the head parts 18 and 19 have screw connection points 23 at regular intervals, via which the lid 16 is screwed to the respective elements. Furthermore, spring elements 24 can be seen which, in the assembled state of the energy storage module 1, generate a pre-tension between the energy storage device 3 accommodated in the housing 2 and the side walls 17a, 17b. The side walls 17a and 17b each have two spring elements 24 between two screw connection points 23, the spring elements 24 being arranged on the right and left of the fixing windows 27 respectively. The head parts 18 and 19 each have a spring element 24 between the screw connection points 23.

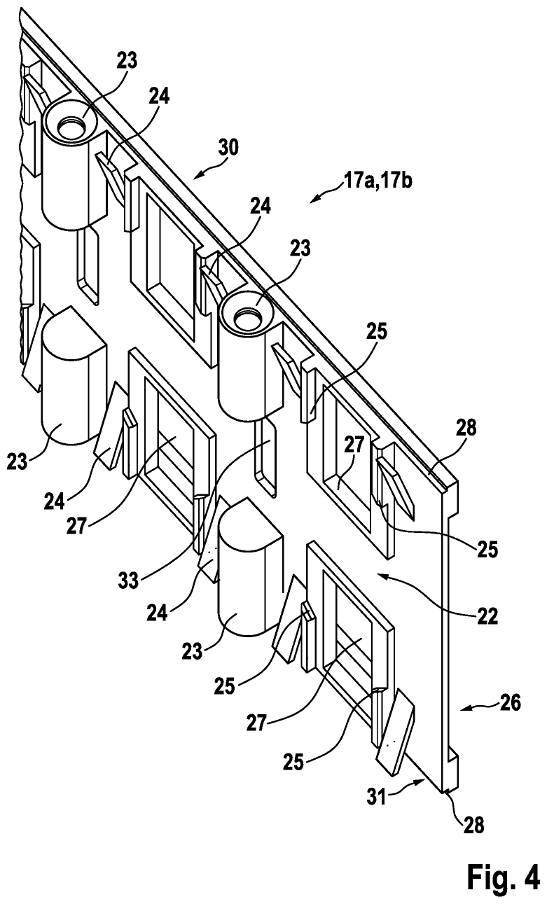

FIG. 4 shows a detailed section of the side walls 17a, 17b. The side panels 17a, 17b and the head parts 18, 19 are each injection molded plastic parts. The spring elements 24, the fastening element receptacles 23 and the latching elements 25 are each molded onto the side walls 17a1, 17b. The fixing windows 27 are each formed as rectangular apertures. The cable feed-throughs 33 are also rectangular openings. It can be seen that a free space is formed centrally in the longitudinal direction of the side wall between the fixing windows 27 and the fastening element receptacles 23 in each case, which free space can be used, for example, as a cable duct 22, the apertures 33 in each case being able to serve for the cable feed-through. The free space also serves to allow the connecting elements 13 to be guided through diagonally between the fastening element receptacles 23. The spring elements 24 are formed at the lower edge 31 as clamping webs formed at an acute angle and pointing downwards, which extend away from the side wall up to a distance of 2 mm. In a symmetrical manner, spring elements 24 are formed at the upper edge 30 pointing upwards. Two latching elements 25 are provided to the left and right of each fixing window 27, each of which has a bearing surface and a latching projection, the bearing surfaces of both latching elements 25 assigned to a fixing window 27 being at right angles to one another and facing one another. As a result, the end face of a connecting element 13 can be held on one of the latching elements 25 and the longitudinal side of a connecting element 13 can be held on the other latching element 25. The opposite end face and the other longitudinal side of the same connecting element 13 are thereby held by the latching elements 25 of the diagonally spaced fixing window 27. The connecting elements 13 can be clicked into the desired position over the latching projections. Along the upper edge 30 and along the lower edge 31, the side wall 17a, 17b each has a corner recess 28 which serves as a support surface and as a lateral boundary for lid 16 and bottom 15. On its side facing away from the energy storage device 3, the side wall 17a, 17b has a recess 26 in which the stiffening part 20 can be accommodated.

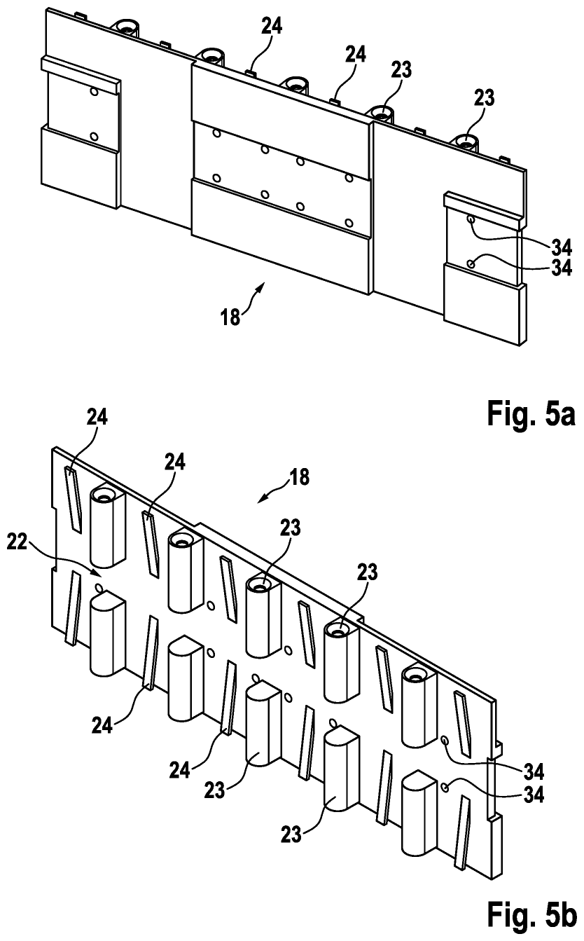

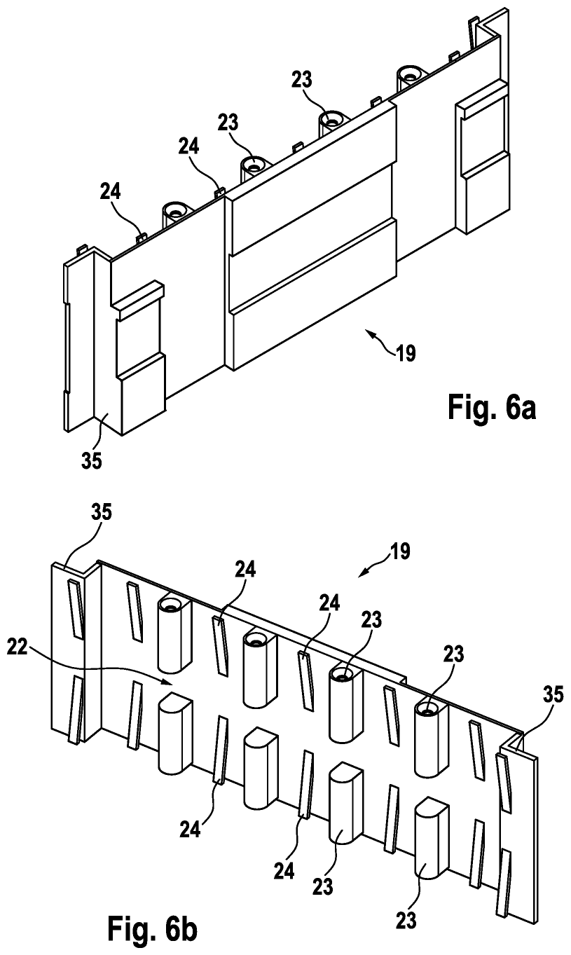

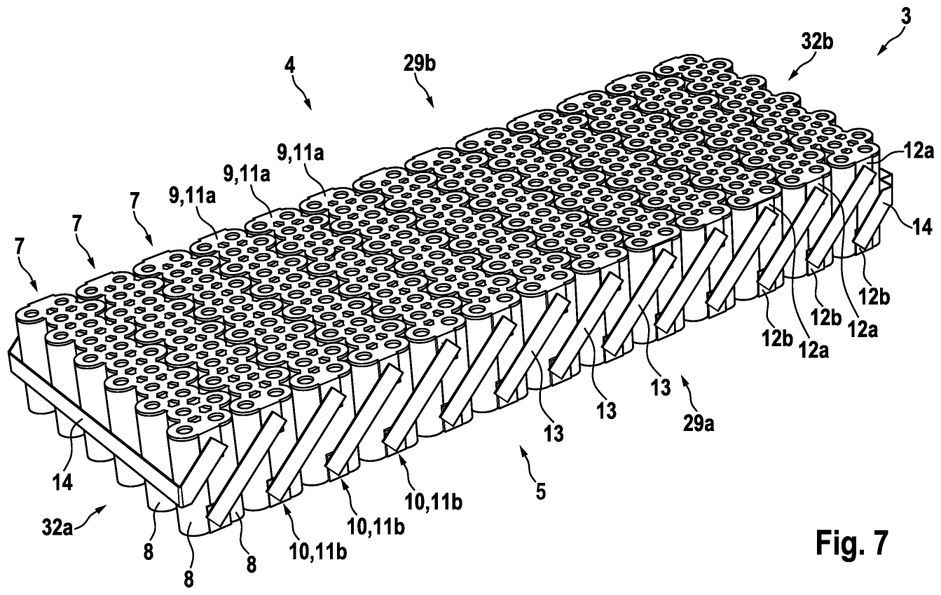

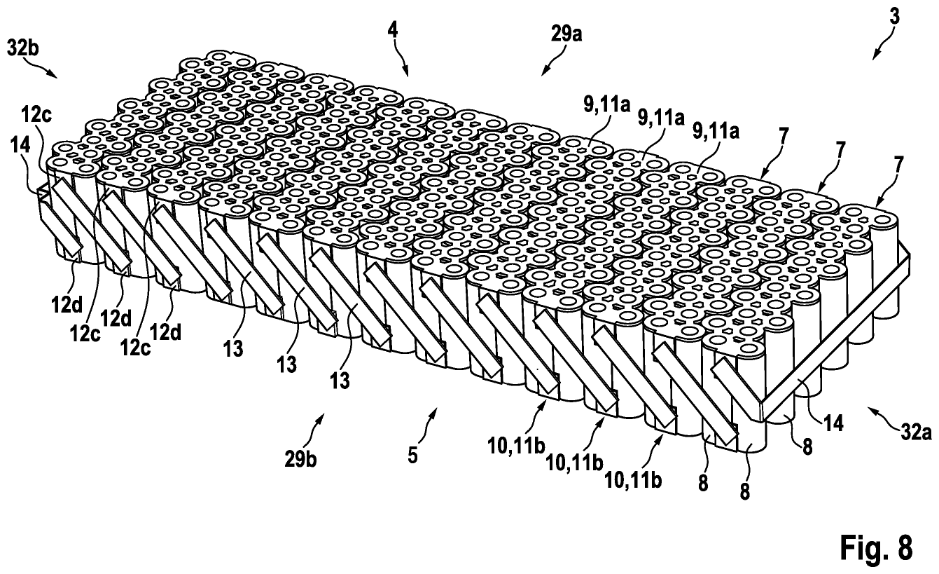

FIG. 5 and FIG. 6 show the head parts of the housing 2, which are also produced by injection molding and are not identical parts due to the geometry of the energy storage units 7. The energy storage cells 8 of the energy storage units 7 are each lined up in a straight line along the side walls 17a, 17b. In contrast, the energy storage cells 8 have a zigzag shape in the transverse direction of the energy storage module 1. Furthermore, through the eleven adjacent pairs of energy storage cells, there are six energy storage cells 8 in the direction of the front-side head part 18 and only five in the direction of the rear-side head part 19. For this reason, the rear head part 19 therefore has two bends 35 on the outside, by means of which in each case the outer energy storage cells 8 of the energy storage unit 7 resting against the rear head part 19 can be supported by the spring elements 24 of the head part. The head parts 18, 19 likewise each have fastening element receptacles 23 in the form of screw connection points, although these project further in the transverse direction than the fastening element receptacles 23 of the side walls due to the geometry of the energy storage units 7 described above. The spring elements 24 of the head parts 18, 19 also project further than those of the side walls 17a, 17b and for this purpose on the one hand are formed further centrally on the head parts and on the other hand have a greater length than the spring elements 24 of the side walls. The front side head part also has a plurality of holes 34 for fastening connecting elements.

FIGS. 7 and 8 show an embodiment of the energy storage device 3 which has the special feature that all the elements of the energy storage device 3 shown in FIGS. 7 and 8 are first connected and fixed to one another and only then are the housing components assembled.

The embodiment shown has thirteen energy storage units 7 arranged side by side. The energy storage units 7 each have eleven energy storage cell pairs which are adjacent in the transverse direction of the energy storage device 3 and are arranged offset from one another in a zigzag pattern. The energy storage cell pairs are each formed by two energy storage cells 8, which are adjacent to each other in the longitudinal direction of the energy storage device 3. All positive poles 9 of the energy storage cells 8 of the energy storage units 7 face the upper side 4 of the energy storage device 3 and are mechanically and electrically connected to one another via a first cell connector 11a, in particular a one-piece cell connector. Correspondingly, all negative poles 10 of the energy storage cells 8 of the energy storage units 7 face the bottom side 5 of the energy storage device 3 and are mechanically and electrically connected to each other via a, in particular one-piece, second cell connector 11b. The cell connectors are each welded or soldered to the energy storage units. Via the first and second cell connectors 11a, 11b, the energy storage cells 8 are fixed to each other in such a way that the same predetermined distance exists between all directly adjacent energy storage cells 8. The cell connectors 11a, 11b each have connecting lugs 12a, 12c and 12b, 12d, respectively, on their opposite end faces, which are bent over onto the first and second side surfaces 29a, 29b of the energy storage device 3, respectively. Diagonally adjacent connection lugs are connected to one another via connecting elements 13. For example, as FIG. 7 shows, the connecting lug 12b of the head-side energy storage unit 7 is connected to the diagonally adjacent connecting lug 12a of the adjacent energy storage unit 7 via a connecting element 13. Accordingly, all connecting elements 13 are arranged parallel to each other on the first side surface 29a. At the same time, as shown in Figure, the connection lug 12d of the head-side energy storage unit 7 is connected via a connection element 13 to the connection lug 12c of the adjacent energy storage unit 7, which is located diagonally thereto. Accordingly, all connecting elements 13 on the second side surface 29b are also arranged parallel to each other. Thus, connecting elements 13 arranged in the transverse direction of the energy storage device 3 are also arranged parallel to each other. Via the connecting elements 13 opposite each other in the transverse direction, adjacent energy storage units 7 are respectively fixed to each other in such a way that the same predetermined distance exists between directly adjacent energy storage cells 8 of the adjacent energy storage units 7 in each case. The connecting elements 13 are each welded or soldered to the connecting lugs 12a-d. The spacing of energy storage cells 8 of adjacent energy storage units 7 corresponds to the spacing of the energy storage cells 8 within the energy storage units 7. Due to the described arrangement of connecting elements 13, the opposing first and third connecting tabs 12a, 12c at the head side of the energy storage device 3 and the opposing second and fourth connecting tabs 12b, 12d at the rear side of the energy storage device 3 are not connected to respective connecting elements 13. Instead, a terminal element 14 is connected to each of these connection lugs on the head side and on the rear side. Positive power is tapped at the head end and negative power is tapped at the rear end. The terminal elements 14 each have contact sections opposite one another in the transverse direction of the energy store 3, which are folded over onto the side surfaces 29a, 29b and are connected to the respective connection lugs 12a, 12c or 12b, 12d. The contact sections thereby run parallel to the connecting elements 13. The contact sections are connected to each other on the head side and on the rear side in each case by a tapping element running in the transverse direction along the end faces. The rear terminal element 14 also has, between the contact sections and the pick-off element, inwardly edged corner recesses in each case, which are adapted to the outer contour of the energy storage unit 7 located on the rear end face 32b and thus ensure the most compact possible design of the energy storage device 3. The described embodiment has the advantage that it provides an energy storage unit which is already stable in itself due to the electrical contact elements welded thereto, such as the cell connectors 11a, 11b or the connecting elements 13 or terminal elements 14, and the energy storage cells 8 or energy storage units 7 connected by the electrical contact elements are spaced apart from one another without spacers arranged therebetween in such a way that they can expand thermally or due to aging without the energy storage unit and, on the other hand, the welded connections between the cells and the cell connectors being damaged thereby.

The features of the invention disclosed in the foregoing description, in the figures as well as in the claims may be essential for the realization of the invention both individually and in any combination.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-15. (canceled)

16. An energy storage module for storing electric energy, comprising an energy storage device having an upper side, a lower side and a substantially rectangular outer periphery, the energy storage device including a plurality of energy storage units each of which has at least two adjacent energy storage cells with poles aligned with the top side and the bottom side of the energy storage device, the positive poles of each of the energy storage units being connected to one another via a first electrically conductive cell connector and the negative poles being connected to one another via a second electrically conductive cell connector and the first cell connector is electrically connected to a first connecting lug and the second cell connector is electrically connected to a second connecting lug, the connecting lugs being arranged on an outer side of the energy storage unit facing a first side surface of the rectangular outer circumference of the energy storage device, wherein in each case the first connection lug of the energy storage units is connected via an electrically conductive connecting element to the second connection lug of that energy storage unit which is adjacent to it in a longitudinal direction of the first side surface, wherein the energy storage module further comprises a housing with a side wall associated with the first side surface, to which the connecting elements are fastened in such a way that they can be fastened to the connection lugs associated with them.

17. The energy storage module according to claim 16, wherein the side wall has fixing windows which are respectively associated with the connection lugs and aligned therewith and via which the connecting elements can be fixed to the connection lugs from the outside of the housing.

18. The energy storage module according to claim 17, wherein the side wall has at least one, in particular two, latching element per fixing window adjacent to the fixing window for fixing the connecting element associated with the fixing window.

19. The energy storage module according to claim 16, wherein the side wall further comprises a plurality, in particular a number corresponding to the number of energy storage cells, of spring elements for generating a bias between the side wall and the energy storage module in the assembled state of the side wall.

20. The energy storage module according to claim 16, wherein the housing further comprises a bottom and/or a lid, wherein the side wall has at its upper and/or lower edge a longitudinally extending corner recess for vertically supporting and laterally fixing the bottom and/or the lid.

21. The energy storage module according to claim 20, wherein the side wall further comprises a plurality of fastening element receptacles facing the upper and or lower edge, by means of which the bottom and/or the lid can be fixed on the associated corner recesses.

22. The energy storage module according to claim 17, wherein the side wall has, on its side facing away from the energy storage module, a stiffening part extending substantially in the longitudinal direction of the side wall and having a plurality of apertures aligned with the fixing windows.

23. The energy storage module according to claim 16, wherein the housing comprises, on at least one of the end faces of the rectangular outer circumference of the energy storage device, a head part covering the adjacent energy storage unit, which has a plurality of fastening element receptacles pointing towards the upper and/or lower edge of the head part, by means of which the bottom and/or the lid can be fixed to the head part bar.

24. The energy storage module according to claim 23, wherein the head part is connected to the free connecting lug of the adjacent energy storage unit via at least one electrically conductive terminal element.

25. The energy storage module according to claim 16, wherein the first cell connector is electrically connected to a third connecting lug and the second cell connector is electrically connected to a fourth connecting lug, which are arranged on a second side surface of the rectangular outer circumference facing the first side surface of the energy storage unit, wherein the third connecting lug of the energy storage units is respectively connected via an electrically conductive connecting element to the fourth connecting lug of the energy storage unit which is respectively adjacent in a longitudinal direction of the first side surface.

26. The energy storage module according to claim 24, wherein the housing further comprises a side wall associated with the second side surface and having the same features as the opposite first side wall.

27. The energy storage module according to claim 16, comprising seven, ten or thirteen energy storage units arranged side by side in the longitudinal direction of the side wall.

28. The energy storage module according to claim 16, wherein the at least two energy storage cells of the energy storage units are adjacent in the longitudinal direction of the side wall, the energy storage unit further comprising a plurality of further pairs of energy storage cells each adjacent in the longitudinal direction of the side wall, the plurality of energy storage cell pairs extending in a direction transverse to the side wall.

29. The energy storage module according to claim 16, wherein in each case all positive and all negative poles of the energy storage cells are aligned with the upper side or the lower side of the energy storage device, so that the connecting elements diagonally connect adjacent energy storage units in each case.
